(19) United States
(12) Patent Application Publication
(10) Pub. No.: US 2007/0249346 A1
(43) Pub. Date: Oct. 25, 2007

(54) Set up for streaming media

(75) Inventors: Jukka Ala-Vannesluoma, Tampere (FI); Timo Tanila, Tampere (FI); Tapio Hinkkanen, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/783,196

(22) Filed: Apr. 6, 2007

Related U.S. Application Data
(60) Provisional application No. 60/789,928, filed on Apr. 7, 2006.

(51) Int. Cl. H04Q 7/20

(52) U.S. Cl. 455/435.1

(57) ABSTRACT

A method, microprocessor, computer program product, terminal and network device are configured to include sending, to a first wireless communication terminal, data indicative of first information relating to one or more parameters supported by a second wireless communication terminal for receiving and/or transmitting a media stream, and receiving, at the second wireless communication terminal, data indicative of second information relating to one or more parameters supported by the first wireless communication terminal for receiving and/or transmitting the media stream. The method, microprocessor, computer program product, terminal and network device are also configured to include determining, on the basis of both said first information and said second information, one or more parameters to be used for sending the media stream between the first and second wireless communication terminals, and sending the media stream between said first and second wireless communication terminals on the basis of said determined one or more parameters.

### CROSS REFERENCE TO RELATED APPLICATIONS

This application claims priority of U.S. Provisional Patent Application Serial No. 60/789,928, filed Apr. 7, 2006. The disclosure of the prior application is hereby incorporated by reference in its entirety.

### FIELD OF THE INVENTION

The present invention relates to a technique for setting up two or more wireless communication terminals for sending a media stream therebetween. In one embodiment, it relates to a method of setting up Third Generation (3G) mobile terminals for a video call therebetween.

### BACKGROUND OF THE INVENTION

Video call capability is considered to be an increasingly important feature for 3G phones.

H.324 is an International Telecommunication Union (ITU) protocol standard for multimedia communication over a general switched networks (GSTN), and 3G-324M is the adaptation of H.324 for wireless circuit-switched networks. The video call setup defined in H.324 is carried out so that first bearer is setup and after that H.324 negotiations are carried out. Even if the H.324 messages are sent in optimal way, the negotiation takes typically at least two roundtrips.

US2006/0029041 describes a technique for reducing the time required to establish calls that implement the H.324 protocol.

### SUMMARY OF THE INVENTION

It is an aim of the present invention to provide a new technique by which call setup times for sending media streams can be yet further reduced.

The present invention provides the following methods, microprocessor, computer program product, wireless communication terminal and network device.

According to one aspect of the invention, there is provided a method, including: sending, to a first wireless communication terminal, data indicative of first information relating to one or more parameters supported by a second wireless communication terminal for receiving and/or transmitting a media stream; receiving, at the second wireless communication terminal, data indicative of second information relating to one or more parameters supported by the first wireless communication terminal for receiving and/or transmitting the media stream; determining, on the basis of both said first information and said second information, one or more parameters to be used for sending the media stream between the first and second wireless communication terminals; and sending the media stream between said first and second wireless communication terminals on the basis of said determined one or more parameters.

According to another aspect of the present invention, there is provided a method, including: (i) determining on the basis of first information relating to one or more parameters supported by said first wireless communication terminal for receiving and/or transmitting a media stream, and second information relating to one or more parameters supported by a second wireless communication terminal for receiving and/or transmitting the media stream, one or more parameters to be used for sending the media stream between the first and second wireless communication terminals; and (ii) configuring the first wireless communication terminal for receiving the media stream from said second wireless communication terminal and/or transmitting the media stream to said second wireless communication terminal on the basis of the determination of (i).

According to another aspect of the invention, there is provided a microprocessor for a first wireless communication terminal, wherein said microprocessor is arranged to (i) determine, on the basis of first information relating to one or more parameters supported by the first wireless communication terminal for receiving and/or transmitting a media stream and second information relating to one or more parameters supported by a second wireless communication terminal for receiving and/or transmitting the media stream, one or more parameters to be used for sending the media stream between the first and second wireless communication terminals; and (ii) configure the first wireless communication terminal for receiving the media stream from said second wireless communication terminal or transmitting the media stream to said second wireless communication terminal on the basis of the determination of (i).

According to another aspect of the invention there is provided a computer program product comprising program code means, which when loaded into a computer, operates to control the computer to perform a method including: (i) determining on the basis of first information relating to one or more parameters supported by said first wireless communication terminal for receiving and/or transmitting the media stream, and second information relating to one or more parameters supported by a second wireless communication terminal for receiving and/or transmitting the media stream, one or more parameters to be used for sending the media stream between the first and second wireless communication terminals; and (ii) configuring the first wireless communication terminal for receiving the media stream from said second wireless communication terminal and/or transmitting the media stream to said second wireless communication terminal on the basis of the determination of (i).

According to another aspect of the invention there is provided a method, including: (i) initiating, at a first wireless communication terminal, a call to a second wireless communication terminal; (ii) determining, on the basis of information sent from said second wireless communication terminal before said call is accepted by said second wireless communication terminal, at least one parameter to be used for sending a media stream between the first and second wireless communication terminals; and (iii) sending the media stream between said first and second wireless communication terminals on the basis of one or more parameters, including said at least one parameter determined in (ii).

According to another aspect of the invention there is provided a wireless communication terminal, which is arranged, in response to receiving a message initiating a video call with another wireless communication terminal and before accepting said video call, to send to said another wireless communication terminal data indicative of information for determining at least one parameter to be used for sending a media stream between the two wireless communication terminals.

According to another aspect of the invention there is provided a network device for relaying information between first and second wireless communication terminals for conducting a call between said first and second wireless communication terminals, wherein the network device is arranged to forward, from the first wireless communication terminal to the second wireless communication terminal, a message initiating a call between said first and second wireless communication terminals, and before the call is accepted by the second wireless communication terminal, to forward from the second wireless communication terminal to the first wireless communication terminal a message including data indicative of information regarding one or more parameters for the sending of a media stream between said first and second wireless communication terminals.

According to another aspect of the invention there is provided a first wireless communication terminal, which is arranged to: send to a second wireless communication terminal, data indicative of first information relating to one or more parameters supported by the first wireless communication terminal for receiving and/or transmitting a media stream; receive data indicative of second information relating to one or more parameters supported by the second wireless communication terminal for receiving and/or transmitting the media stream; determine, on the basis of both said first information and said second information, one or more parameters to be used for sending the media stream between the first and second wireless communication terminals; and send the media stream between said first and second wireless communication terminals on the basis of said determined one or more parameters.

According to another aspect of the invention there is provided a first wireless communications terminal, which is arranged to:initiate a call to a second wireless communication terminal; determine on the basis of information sent from said second wireless communication terminals before said call is accepted by said second wireless communication terminal, at least one parameter to be used for sending a media stream between the first and second wireless communication terminals; and send the media stream between said first and second wireless communication terminals on the basis of one or more parameters, including said at least one parameter.

### BRIEF DESCRIPTION OF THE DRAWINGS

By way of non-limiting example only, embodiments of the present invention are described in detail hereunder with reference to the accompanying drawings, in which:

FIG. 1 illustrates the connection architecture to which a technique according to a first embodiment of the present invention is applied for setting up 3G-324M calls between two terminals;

FIG. 2 illustrates an exchange of messages between two 3G terminals according to the technique of the first embodiment of the present invention;

FIG. 3 illustrates a handset adapted for use in the technique according to the first embodiment of the present invention;

FIG. 4 illustrates some steps of the technique according to the first embodiment;

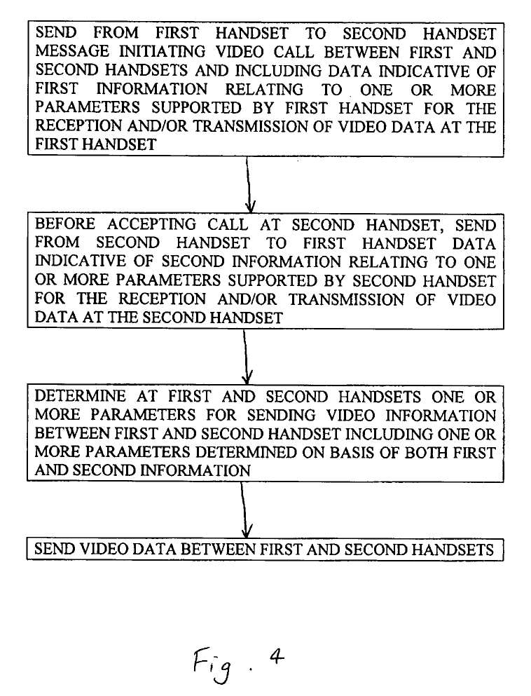

FIG. 5 illustrates an exchange of messages between two 3G terminals according to a second embodiment of the present invention; and

FIG. 6 illustrates an exchange of messages between two 3G terminals according to a third embodiment of the present invention;

### DESCRIPTION OF PREFERRED EMBODIMENTS

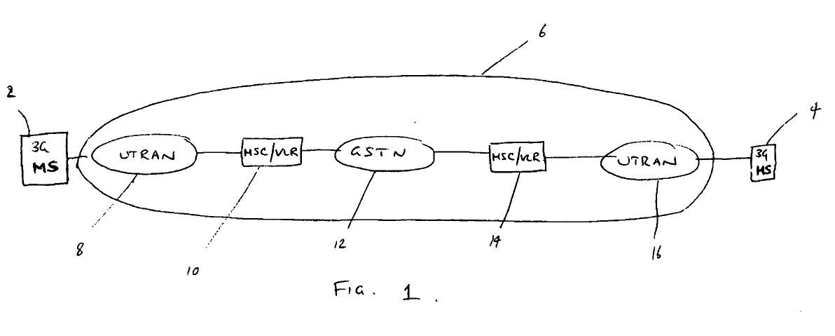

A first embodiment of the present invention is a technique for setting up video calls between two 3G terminals via a general switched network (GSTN). The functional elements are illustrated in FIG. 1.

The originating 3G terminal initiates the call set-up procedure by sending a SETUP message to the originating Mobile Switching Centre (MSC)/ Visitor Location Register(VLR) 10. As described below, the SETUP message includes an information element (IE) identifying the encoding and decoding systems (codecs) supported by the originating 3G terminal for the reception and transmission of video and audio data by it, together with an indication of any one or more codecs preferred by the originating 3G terminal 2. This message is forwarded to the terminating MSC/VLR 14 via a general switched network (GSTN) 12, and the terminating MSCNVLR 14 sends to the terminating 3G terminal 4 a SETUP message including said IE. For the purpose of conciseness, all elements between the 3G terminals are referred to as the Network 6. The terminating 3G terminal 4 responds to this message from the Network 6 by sending a CALL-CONFIRMED message including an information element (IE) identifying the codecs supported by the terminating 3G terminal 4 for the reception and transmission of video and audio data by it, together with an indication of any one or more codecs preferred by the terminating 3G terminal 4. The content of this information element included in the CALL-CONFIRMED message is independent of the content of the information element received in the SETUP message. The terminating 3G terminal 4 sends out the CALL-CONFIRMED message including such information element without first being aware of the content of the information element in the SETUP message received from the originating 3G terminal 2 via the Network 6. The Network 6 in turn sends a CALL PROCEEDING message to the originating 3G terminal 2 including the IE included in the CALL CONFIRMED message received from the terminating 3G terminal 4. The terminating 3G terminal 4 sends an ALERTING message to the Network 6 informing it that ringing has started at the terminating 3G terminal 4 and consequently the Network 6 connects the ringing tome to the originating 3G terminal in an ALERTING message from the Network 6 to the originating 3G terminal 2.

As discussed below, the IEs in the SET UP and CALL CONFIRMED MESSAGES may also include information for determining other parameters to be used for video and audio data transmission between the two 3G terminals, including information for determining the multiplex level, multiplex entry table and the adaptation layer parameters to be used for the transmission of video and audio data between the two 3G terminals. Part of this information may be master-slave determination information. Other information that may be included is the vendor ID, a skew indication and a temporalSpatialTradeOff indication.

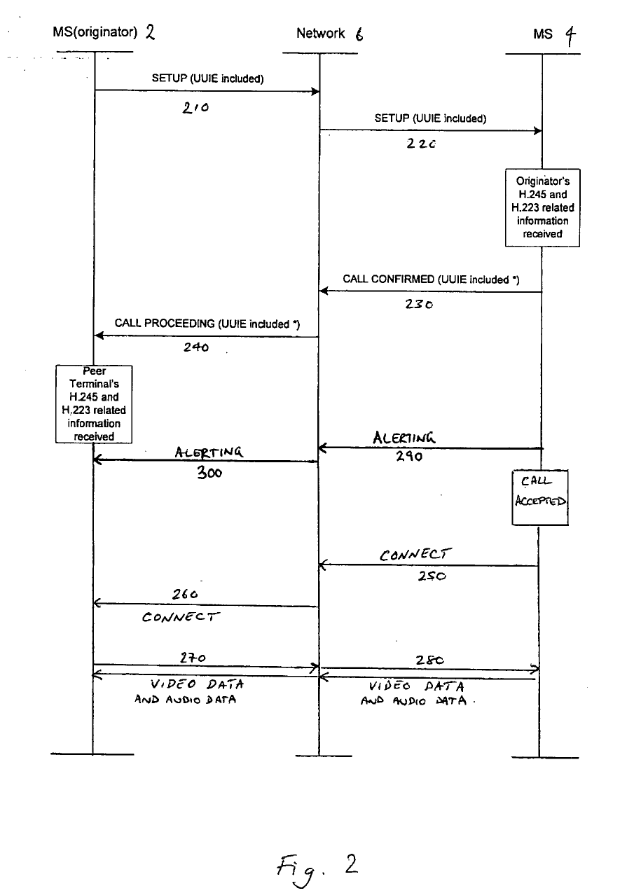

This exchange of control signals for bearer set up via Layer 3 messages and UUIE (User-User Information Element) is illustrated as steps 210, 220, 230 and 240 in FIG. 2. The UUIE may, for example, be a Bearer Capability Information Element (BCIE).

Once the terminating 3G terminal accepts the call, it sends a CONNECT message 250 to the Network 6, and the Network 6 in turn sends a CONNECT message 260 to the originating 3G terminal 2. The two 3G terminals 2, 4 are by now already in possession of sufficient information to deduce the connection parameters (codecs, etc.), and are therefore able to start exchanging audio and video and audio data immediately (i.e. immediately after the bearer establishment), which exchange of audio and video and audio data is shown as steps 270 and 280 in FIG. 2.

As mentioned above, all the information that needs to be exchanged for commencing video and audio data transmission is exchanged during bearer setup i.e. in control level signalling.

Below is a description of the information that is exchanged (or decided in some other way) during bearer setup (via error protected channel) in this first embodiment of the invention, together with an explanation of how each of the two 3G terminals can determine from the control information exchanged therebetween which parameters are to be used for the exchange of audio and video and audio data therebetween.

Terminal Capability Information:

The terminal capability information set includes information of the supported codecs and other H.324 parameters of the respective 3G terminal. In addition, the set indicates which codecs are preferred by the respective 3G terminal (i.e. capability descriptor is included) unless the preferences are common for all terminals and are predetermined (e.g. predetermined according to a standard specification). The content of the terminal capability information set could be the same as defined in H.245 or equivalent information on at least relevant parts could be included in the IEs of the SET UP and CALL CONFIRMED messages. The 3G terminals are able to select which codecs to use as they know each other's capabilities. This also makes it possible to adopt an asymmetric codec configuration, i.e. to use different codecs in different directions. Information relating to the symmetry limitations may also be part of the IEs included in the SET UP and CALL CONFIRMED messages.

Master-slave Determination:

If the preferences are not common for both 3G terminals (i.e. or not predetermined according to a standard specification), a master-slave determination is carried out, by which one of the 3G terminals is designated as the master and the other as the slave for the call. In case of any conflicts, the master's preferences are honoured.

There are several options for deciding which of the terminals is to be the master:

Option 1:

Exchange master-slave determination information of the kind defined in H.245, or provide at least equivalent information in the IEs sent between the two terminals. In one example, the terminals specify in the respective IE a terminal type and a random determination number. If the terminal types match, the random determination number is used for deciding which terminal is master and which is slave. Also a recovery mechanism is provided in the unlikely event that both the terminal types and the random determination numbers happen to match. One option is to predetermine a rule by which the originating end is then designated as the master (or a rule specifying the opposite, if preferred). Another consideration relates to how the determination number is decided in each terminal. As the message exchange in control level signalling may be such that one of the terminals first sends a message including its determination number and the other terminal then responds to it by sending a message including its own determination number, it is preferable to avoid a situation where the responding 3G terminal can check the received determination number and purposely select a its own determination number such that it becomes the master.

Option 2:

Send only (or use only) information of terminal type, and predetermine a rule by which, in the event of the terminal types matching, the call originating terminal is designated as the master and the terminating terminal is designated as the slave (or a rule to the opposite effect, if preferred).

Option 3:

Master-slave determination is not carried out at all. Instead, all preferences are predetermined according to a standard specification.

Multiplex Level:

The terminal capability information exchanged between the terminals also specifies the multiplex levels supported by the respective terminal, and additionally specify a respective preferred multiplex level. The lower of the two preferred multiplex levels is adopted by the two 3G terminals as the multiplex level for the exchange of video and data transmission exchanged therebetween. Other options include the following.

Option 1:

The preferred multiplex level is specified in an information element including other capability information such as the codecs supported by the respective terminal.

Option 2:

The preferred multiplex level is specified in a separate information element.

Option 3:

No preferred multiplex level is specified. Instead, the information exchanged between the terminals specify the multiplex levels supported by the respective terminal, and the highest common level is selected by both terminals. For example, in the event that the information from terminal A specifies that it supports levels 0, 1, 2 and 2 with optional header, and the information from terminal B specifies that it supports levels 0, 1 and 2, then level 2 is selected by both terminals.

Multiplex Entries:

The video and audio data sent by the terminals is multiplexed and. there are the following options for exchanging/deducing the initial multiplex entry table.

Option 1:

The terminal capability information set defines the supported codecs in capability entries. The capability entry number is used when sending data to the remote terminal. The entry number corresponds to a multiplex table entry: <channel number> until closing flag. Segmentation of the channels is assumed so that audio channels are non-segmentable and video channel are segmentable. Other channel parameters (e.g. MPEG4 DCI (Decoder Configuration Information), H.263 parameters, AMR (Adaptive Multi-Rate, which is the mandatory audio codec for 3G -324M, which is the umbrella standard for video call over a wireless circuit-switched network based on H.324) parameters) have default values which are defined in specification.

Option 2:

The multiplex entries are exchanged during bearer setup. In addition, the channel parameters are relayed (segmentable/non-segmentable, etc.) to the remote terminal.

Used Adaptation Layers:

There are the following options for indicating or deducing which adaptation layer is used for each channel.

Option 1:

The information sent from each terminal specifies adaptation layers and parameters for video and for audio. In case of any conflict between the adaptation layers and parameters specified by the terminals, the adaptation layers and parameters specified by the master terminal are used.

Option 2:

The adaptation layers and parameters for video and audio channels are predetermined in accordance with a standard specification.

The technique described above as an embodiment of the invention has the following advantageous features: (a) video call setup times are very close to voice calls if not equally short, as the calling party has sufficient information to initialise the codecs to be used well before the CONNECT message arrives from the terminating 3G terminal 4 via the Network 6.; (b) the technique is backwards compatible with the legacy terminals; (c) the fallback can be made to any H.324 based negotiation method (including other speed up techniques); and (iv) the technique is not tied to any specific codec, i.e. the solution is compatible also with future codecs.

H.245 is the Control protocol for multimedia communication (H.324, 3G -324M), and H.263 is the Mandatory video codec for 3G -324M.

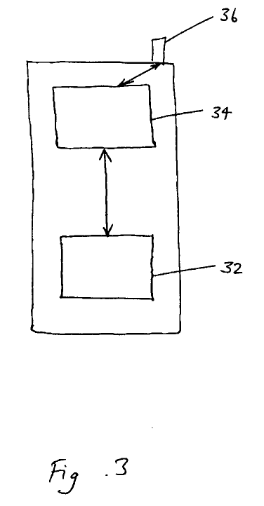

FIG. 3 illustrates a handset according to an embodiment of the present invention for use as the 3G terminals in the method described above. The handset includes an antenna 36 and transceiver 34 for sending and receiving radio signals; and a microprocessor 32 for receiving information included in the information element of either the SETUP message or the CALL PROCEEDING message (depending on whether the handset is the terminating handset or the originating handset) regarding the parameters supported by the other handset for the reception and transmission of video and audio data, and determining on the basis of such information and information relating to the corresponding parameters supported by the handset of which it is part, one or more parameters to be used for the exchange of video and audio data between the handset of which it is part and the other handset.

Appropriately adapted computer program code product may be used for implementing the functions of the microprocessor 32. The program code product for providing the operation may be stored on and provided by means of a carrier medium such as a carrier disc, card or tape. Another possibility is to download the program code product via a data network.

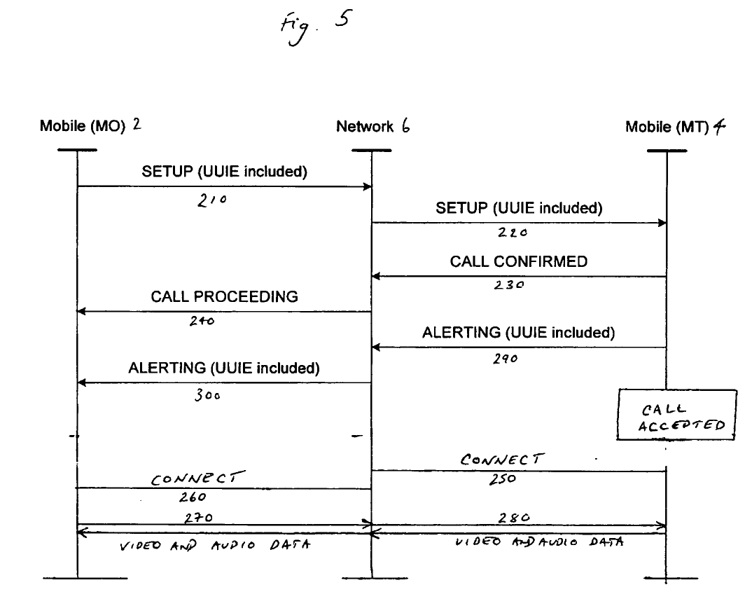

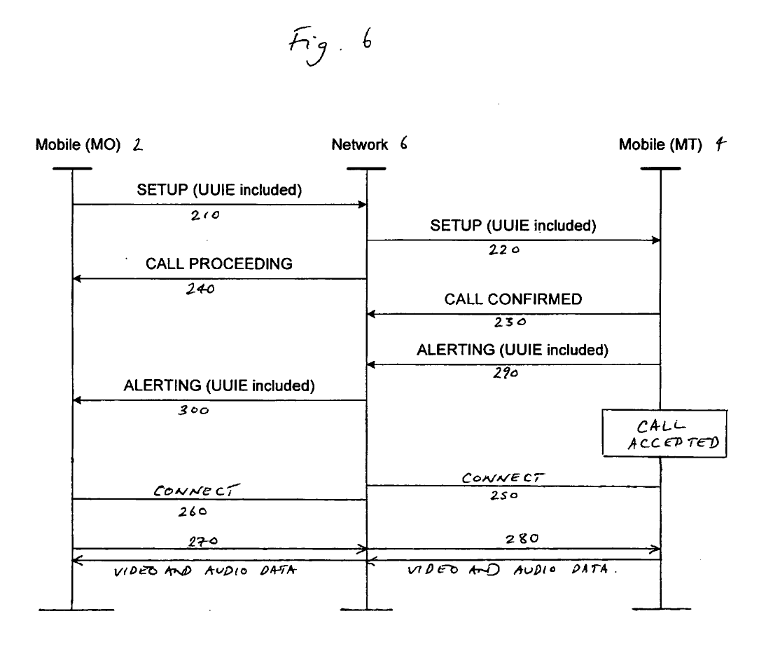

According to one variation illustrated in FIG. 5, the information element identifying the encoding and decoding systems (codecs) supported by the terminating 3G terminal 4 for the reception and transmission of video and audio data by it etc. is instead included with the ALERTING message 290, 300 sent from the terminating 3G terminal 4 to the originating 3G terminal 2 via the Network before the call is accepted by the terminating 3G terminal 4. This variation is particularly useful where there is a possibility that the Network might generate and send an early CALL PROCEEDING message before receiving the CALL CONFIRMED message from the terminating 3G terminal 4, as illustrated in FIG. 6.

The applicant draws attention to the fact that the present invention may include any feature or combination of features disclosed herein either implicitly or explicitly or any generalisation thereof, without limitation to the scope of any definitions set out above. In view of the foregoing description it will be evident to a person skilled in the art that various modifications may be made within the scope of the invention.

The following modifications/variations are mentioned, by way of non-limiting example only.

The invention is not limited to 3G wireless terminals. The invention is also applicable, for example, to other terminals such as Unlicensed Mobile Access (UMA) terminals such as WLAN terminals, or terminals compatible with future packet-oriented networks, such as a Fourth Generation (4 ) network.

The invention is not limited to the connection architecture illustrated in FIG. 1. The invention is also applicable to other connection architectures.

The invention is not limited to including the information elements in the particular types of messages mentioned above, such as the SETUP messages, CALL-CONFIRMED messages, CALL PROCEEDING messages and ALERTING messages. The information elements may, for example, also be included in other types of signalling messages sent before call acceptance with the same kind of functionality but with different names according to different standards.

What is claimed is:

1. A method, including:
sending, to a first wireless communication terminal, data indicative of first information relating to one or more parameters supported by a second wireless communication terminal for receiving and/or transmitting a media stream;
receiving, at the second wireless communication terminal, data indicative of second information relating to one or more parameters supported by the first wireless communication terminal for receiving and/or transmitting the media stream;
determining, on the basis of both said first information and said second information, one or more parameters to be used for sending the media stream between the first and second wireless communication terminals; and
sending the media stream between said first and second wireless communication terminals on the basis of said determined one or more parameters.

2. The method of claim 1, wherein said first information includes information relating to encoding and/or decoding systems supported by the second wireless communication terminal and the second information includes information relating to encoding and/or decoding systems supported by the first wireless communication terminal, and including the step of determining, on the basis of said first information and said second information, which one or more encoding and/or decoding systems are to be used for sending the media stream between the first and second wireless communication terminals.

3. The method of claim 1, wherein said first information also includes information relating to multiplex levels supported by the second wireless communication terminal, and the second information includes information relating to multiplex levels supported by the first wireless communication terminal, and including the step of determining, on the basis of said first information and said second information, which one or more multiplex levels are to be used for sending the media stream between the first and second wireless communication terminals.

4. The method of claim 1, wherein the media stream includes video data.

5. The method of claim 4, wherein the media stream includes audio data.

6. A method, including: (i) determining on the basis of first information relating to one or more parameters supported by said first wireless communication terminal for receiving and/or transmitting a media stream, and second information relating to one or more parameters supported by a second wireless communication terminal for receiving and/or transmitting the media stream, one or more parameters to be used for sending the media stream between the first and second wireless communication terminals; and
(ii) configuring the first wireless communication terminal for receiving the media stream from said second wireless communication terminal and/or transmitting the media stream to said second wireless communication terminal on the basis of the determination of (i).

7. The method of claim 6, wherein the media stream comprises audio data or video data.

8. The method of claim 6, wherein the first information includes encoding or decoding information related to systems supported by the second wireless communication terminal, and wherein the second information includes encoding or decoding information related to systems supported by the first wireless communications terminal.

9. The method of claim 8, wherein the first and second information comprises multiplex levels.

10. A microprocessor for a first wireless communication terminal, wherein said microprocessor is arranged to (i) determine, on the basis of first information relating to one or more parameters supported by the first wireless communication terminal for receiving and/or transmitting a media stream and second information relating to one or more parameters supported by a second wireless communication terminal for receiving and/or transmitting the media stream, one or more parameters to be used for sending the media stream between the first and second wireless communication terminals; and (ii) configure the first wireless communication terminal for receiving the media stream from said second wireless communication terminal or transmitting the media stream to said second wireless communication terminal on the basis of the determination of (i).

11. The microprocessor of claim 10, wherein the media stream comprises audio data or video data.

12. The microprocessor of claim 10, wherein the first information includes encoding or decoding information related to systems supported by the second wireless communication terminal, and wherein the second information includes encoding or decoding information related to systems supported by the first wireless communications terminal.

13. The microprocessor of claim 12, wherein the first and second information comprises multiplex levels.

14. A computer program product comprising program code means, which when loaded into a computer, operates to control the computer to perform a method including: (i) determining on the basis of first information relating to one or more parameters supported by said first wireless communication terminal for receiving and/or transmitting the media stream, and second information relating to one or more parameters supported by a second wireless communication terminal for receiving and/or transmitting the media stream, one or more parameters to be used for sending the media stream between the first and second wireless communication terminals; and (ii) configuring the first wireless communication terminal for receiving the media stream from said second wireless communication terminal and/or transmitting the media stream to said second wireless communication terminal on the basis of the determination of (i).

15. A method, including:
(i) initiating, at a first wireless communication terminal, a call to a second wireless communication terminal;
(ii) determining, on the basis of information sent from said second wireless communication terminal before said call is accepted by said second wireless communication terminal, at least one parameter to be used for sending a media stream between the first and second wireless communication terminals; and
(iii) sending the media stream between said first and second wireless communication terminals on the basis of one or more parameters, including said at least one parameter determined in (ii).

16. The method of claim 15, comprising including in a SETUP message, sent to the second wireless communication terminal, data indicative of information regarding at least one parameter for receiving and/or transmitting the media stream at the first wireless communication terminal, and including in a CALL PROCEEDING message, received by the first wireless communication terminal, data indicative of information regarding at least one parameter for receiving and/or transmitting the media stream at said second wireless communication terminal.

17. The method of claim 15, comprising including in a SETUP message, sent to the second wireless communication terminal, data indicative of information regarding at least one parameter for receiving and/or transmitting the media stream at said first wireless communication terminal, and including in an ALERTING message, received by the first wireless communication terminal, data indicative of information regarding at least one parameter for receiving and/or transmitting the media stream at said second wireless communication terminal.

18. The method of claim 15, wherein the media stream includes video data.

19. The method of claim 18, wherein the media stream includes audio data.

20. A wireless communication terminal, which is arranged, in response to receiving a message initiating a video call with another wireless communication terminal and before accepting said video call, to send to said another wireless communication terminal data indicative of information for determining at least one parameter to be used for sending a media stream between the two wireless communication terminals.

21. A network device for relaying information between first and second wireless communication terminals for conducting a call between said first and second wireless communication terminals, wherein the network device is arranged to forward, from the first wireless communication terminal to the second wireless communication terminal, a message initiating a call between said first and second wireless communication terminals, and before the call is accepted by the second wireless communication terminal, to forward from the second wireless communication terminal to the first wireless communication terminal a message including data indicative of information regarding one or more parameters for the sending of a media stream between said first and second wireless communication terminals.

22. A first wireless communication terminal, which is arranged to:
send to a second wireless communication terminal, data indicative of first information relating to one or more parameters supported by the first wireless communication terminal for receiving and/or transmitting a media stream;
receive data indicative of second information relating to one or more parameters supported by the second wireless communication terminal for receiving and/or transmitting the media stream;
determine, on the basis of both said first information and said second information, one or more parameters to be used for sending the media stream between the first and second wireless communication terminals; and
send the media stream between said first and second wireless communication terminals on the basis of said determined one or more parameters.

23. A first wireless communications terminal, which is arranged to:
initiate a call to a second wireless communication terminal;
determine on the basis of information sent from said second wireless communication terminals before said call is accepted by said second wireless communication terminal, at least one parameter to be used for sending a media stream between the first and second wireless communication terminals; and
send the media stream between said first and second wireless communication terminals on the basis of one or more parameters, including said at least one parameter.

24. A wireless communication terminal including a microprocessor according to claim 10.
